(19) United States
(12) Patent Application Publication
(10) Pub. No.: US 2010/0309317 A1
(43) Pub. Date: Dec. 9, 2010

(54) DEVICE AND METHOD FOR DETECTING UNUSED TV SPECTRUM FOR WIRELESS COMMUNICATION SYSTEMS

(75) Inventors: Shiquan Wu, Nepean (CA); Jung Yee, Ottawa (CA)

Correspondence Address: PROCOPIO, CORY, HARGREAVES & SAVITCH LLP, 525 B STREET, SUITE 2200, SAN DIEGO, CA, 92101, US

(73) Assignee: WI-LAN INC., Ottawa (CA)

(21) Appl. No.: 12/478,149

(22) Filed: Jun. 4, 2009

(51) Int. Cl. H04N 17/00; H04B 17/00

(52) U.S. Cl. 348/180; 455/67.11; 348/E17.001

(57) ABSTRACT

TV white space spectrum sensors and methods for detecting and managing the white space are provided. The sensor is provided with a spectrum detector/analyzer, which senses and analizes the wireless signals present in a spectrum of interest, identifies white space, and assigns the white space to secondary services. For reducing the white space detection time, the sensor uses a group detection method whereby multiple channels are sensed simultaneously. For reducing the sensor cost, the dynamic range of the sensor is reduced by operating the sensor in saturation for signals with the energy higher than a threshold. The sensor is also provided with a spectrum manager/planner capable of understanding a plurality of air interface standards, reserving and providing the right amount of white space spectrum to each application, based on the respective standard requirements. The particular architectures used by the sensor result in an affordable addition to any wireless device.

### RELATED APPLICATIONS

This invention is related to the co-pending U.S. patent application Ser. No. 12/078,979, filed Apr. 9, 2008, entitled “A System and Method for Utilizing Spectral Resources in Wireless Communications”, which is hereby incorporated by reference.

### FIELD OF THE INVENTION

This invention generally relates to detection of white space and use of the detected white space for data communication.

### BACKGROUND

Various regulatory bodies were created in many countries with a view to provide a centralized, tightly controlled allocation of spectrum resources for specific uses and, in most cases, to license the rights to parts of the spectrum. Thus, these regulatory bodies have the mandate to allocate the unused parts of the spectrum (which have never been licensed), or to reallocate any spectrum that becomes free as a result of technical changes. These frequency allocation plans mandate, in many cases, that specified parts of spectrum remain unused between allocated bands for technical reasons, such as for example to avoid interference. For example, the Federal Communications Commission (FCC) is the regulatory body that mandates use of the spectrum in the United States and Canadian Radio-television Telecommunications Commission is its Canadian counterpart.

Different countries use different standards for TV broadcasting as well as different allocation of the spectrum to the broadcast channels, different channel parameters, etc. For example, in the United States, the digital TV broadcasters currently use the VHF (very high frequency) spectrum and/or the lower part of the UHF (ultra high frequency) spectrum between 54 MHz and 698 MHz.

The wireless microphones also transmit on RF frequencies in the UHF and VHF spectrum bands. Unfortunately, there are many different standards, frequency plans and transmission technologies used by the wireless microphones. For example, wireless microphones could use UHF and VHF frequencies, frequency modulation (FM), amplitude modulation (AM), or various digital modulation schemes. Some models operate on a single fixed frequency, but the more advanced models operate on a user selectable frequency to avoid interference, and allow use of several microphones at the same time.

There is a global trend to transition from analog TV to digital TV (DTV); DTV provides a better viewing experience and with personalized and interactive services while achieving a more efficient use of the spectrum. More importantly, conversion to the DTV results in important bandwidth becoming free in the parts of the spectrum occupied now by the analog TV broadcast. This is because each TV station broadcasting DTV signals in a certain geographic region/area (known as a TV market) will use a limited number of channels, so that the spectrum not allocated to DTV broadcast in that region will became free after transition to digital TV broadcast.

Analog-to-digital TV migration opens the way to providing a variety of new, dedicated services to individual/family subscribers. In the United States, the FCC has mandated that all full-power television broadcasts will use the ATSC (Advanced Television Systems Committee) standards for DTV by the middle of 2009. Currently, channels 2 through 51 are being reallocated to the DTV broadcast; When transition to DTV ends, every one of the 210 TV markets in the US will have 15-40 channels not used by TV broadcasting. Those vacant channels are called “white space”. Access to vacant spectrum facilitates a market for low-cost, high-capacity, mobile wireless broadband networks, including emerging indoor networks. Using this locally available spectrum, the wireless broadband industry could deliver Internet access to every household for as little as $10 a month by some estimates.

On Nov. 14, 2008, the FCC approved the use of TV white space spectrum by unlicensed wireless applications and devices, but added some conditions under which these so called “secondary services” would have to perform with a view to prevent interference with the “primary services” such as TV broadcast and wireless microphones, active in the respective area. Thus, the signals radiated by any “white space device” (WSD) operating in the ATSC spectrum, must follow the FCC regulations so that the quality of the primary services, or any emerging services already deployed or which will be deployed in that area will not be degraded by these secondary services. The terms “coexistence” and “collocation” are used for the requirements that must be accounted for when designing and using any white space device.

For compliance with these requirements, FCC mandates that both fixed and portable white space devices include geo-location and sensing capabilities and use a database, called here the “white space (WS) database”, with the information regarding the primary services active in each TV market. The WS database will include the TV channel allocation and the location of main venues, such as stadiums, theatres, etc that use wireless microphones. The database access and sensing capabilities should enable the new white space devices to share the unused spectrum with secondary services, without interfering with the primary services in that area, by ensuring compliance with FCC rules. For the fixed WS devices, the maximum transmitted power should be 1 watt and the EIPR (Equivalent Isotropically Radiated Power) must be up to 4 watts. Any portable WS device that does not have geo-location capabilities and access to the FCC database must operate under control of a fixed WSD, which will provide the required geo-location capabilities and use of the FCC database. The portable devices that don't have geo-location capability and are not controlled by a WS device with geo-location capabilities are limited to 50 mw EIRP and are subject to additional requirements.

The wireless industry is considering using the white space by developing standards on technologies convergence into an architecture that is comfortable, easy to use and attractively priced. For example, the IEEE 802.22 Working Group, formed in 2004, received the mandate to develop a standard for Wireless Regional Area Networks (WRAN). The mission for this technology is to provide rural area broadband services to single-family residential, multi-dwelling units, small office/home office, small businesses, etc.

In order to efficiently use the white space taking into account the coexistence aspect, the WS devices must be equipped with mechanisms capable of detecting a vacant channel and utilize it, currently referred to as “white space spectrum sensors”, or “white space sniffers”, or simply “sniffers”. Spectrum sniffers are very important for ensuring the coexistence requirements and correcting eventual errors or delays in the database updates, or for WSDs that do not have geo-location capabilities. Any acceptable design for these devices should add only a small extra cost to the entire WDS, while performing an accurate detection of the white space and still enabling the performance parameters specified by the FCC. For example, the FCC defines sensitivities up to −114 dBm, which is at least 20 dB below the normal sensitivity level of primary user receivers, to cater for the possibility of secondary user nodes hidden from primary users of the spectrum. This high sensitivity requirement coupled with other impairments, such as noise uncertainty and fading, impose major challenges for spectrum sensing designs.

Current attempts to design spectrum sensors can be generally classified into three major categories, namely, energy detection, matched filtering and cyclostationary detection. However, to date, there is no method or product that provides satisfactory solutions to the problem of identifying pieces of white space in an area of interest. Therefore, there is a need to provide an inexpensive and efficient way to detect the white space spectrum that is reserved but not used by the primary services in a certain area, without affecting operation of the existent services.

### SUMMARY OF THE INVENTION

Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts are provided by the entire disclosure. Also, the following meanings shall apply to all instances of each of the terms identified below, except in instances where otherwise clearly stated, or in specific instances where, from the specific context in which the term appears, a different meaning is clearly stated.

It is an object of the present invention to provide devices, systems and methods for detecting unused TV spectrum for secondary uses. Another object of the invention is to provide cost effective devices and systems that perform fast scanning of the TV spectrum, while handling the high dynamic range of the sensed signals.

It is another object of the invention to provide a white space spectrum sensor that is an affordable addition to wireless devices, and detects fast a piece of white space of a size of interest. The sensor may also be used to update any spectrum occupancy database, if available, with current spectrum occupancy information.

Accordingly, the invention provides a white space spectrum sensor for enabling implementation of a secondary service application from a wireless device, comprising: a spectrum detector/analyzer for identifying a piece of white space spectrum of a specified width; a spectrum manager for establishing the specified width based on requirements of the secondary service application and reserving the piece of white space spectrum for the secondary service application; and a configurable interface for enabling integration of the sensor with the wireless device.

The invention is also directed to a white space spectrum sensor for enabling implementation of a secondary service application at a wireless device, comprising: a spectrum detector/analyzer for analyzing a piece of spectrum of a specified width to confirm that the piece of spectrum is not occupied; a spectrum manager for establishing the specified width based on requirements of the secondary service application and reserving the piece of spectrum for the secondary service application; and a configurable interface for enabling integration of the sensor with the wireless device.

A spectrum detector/analyzer for detecting and analyzing signals present in the spectrum of a band B allocated to the TV broadcast is also described. In general terms, the spectrum detector/analyzer comprises an antenna unit for acquiring wireless signals present in band B; a sampler for digitizing the signals acquired by the antenna unit to provide digitized samples; and a baseband (BB) processor for analyzing the digitized samples and identifying a piece of unused spectrum in the bandwidth allocated to the TV broadcast by detecting a known signal sequence present in the DTV broadcast according to a DTV standard pertinent to the respective TV broadcast.

According to another embodiment of the invention, a spectrum detector/analyzer for detecting and analyzing signals sensed over a spectrum of width B allocated to the TV broadcast, comprises: an antenna unit for acquiring wireless signals present in n sub-bands established over the spectrum allocated to the TV broadcast, a sub-band SBₖ having a certain width Bₖ where k ε[1,n] and n≧1; a down-conversation unit for down-converting the signals received from the antenna unit in each sub-band SBₖ to low-band signals extending over a low-band of width Bₖ; a sampler for sampling the low-band signals in each sub-band to provide digitized samples from the low-band signals; and a baseband processor for analyzing the digitized samples received from the sampler and identifying a piece of unused spectrum in the bandwidth allocated to the TV broadcast.

According to still another embodiment of the invention, the spectrum detector/analyzer for detecting and analyzing signals sensed over a spectrum of width B allocated to the TV broadcast, comprises: an antenna unit for acquiring wireless signals present over the spectrum allocated to the TV broadcast; a sampler for sampling the signals acquired by the antenna unit to provide digitized samples, the sampler being operated so as to achieve a saturated state for signals stronger than a specified value; and a baseband (BB) processor for analyzing the digitized samples received from the sampler and identifying a piece of unused spectrum in the bandwidth allocated to the TV broadcast by detecting the saturation state of the sampler.

In still another embodiment of the invention, a method of detecting and analyzing signals present in the spectrum allocated to the TV broadcast is provided. The method comprises: a) acquiring wireless signals present in the band allocated to the TV broadcast; b) sampling the signals acquired in step a) to provide digitized samples, using a sampler operated in a operating point selected to achieve a saturated state for signals stronger than a specified value; and c) analyzing the digitized samples received from the sampler and identifying a piece of unused spectrum in the bandwidth allocated to the TV broadcast by detecting the saturation state of the sampler.

Another embodiment of the invention is directed to a method of detecting and analyzing signals present in a spectrum of width B allocated to the TV broadcast, comprising: a) establishing n sub-band over the band B of the spectrum allocated to the TV broadcast, a sub-band SBₖ having a certain width Bₖ where k ε[1,n] and n≧1; b) acquiring wireless signals present in the sub-band SBₖ; c) down-converting the signals acquired in the sub-band SBₖ to low-band signals in a low band of a width Bₖ; d) sampling the low-band signals in each sub-band SBₖ to provide digitized samples of the low-band signals; e) analyzing the digitized samples received from the sampler to measure the energy of the sampled low-band signals; and f) repeating steps c) to e) until a piece of unused spectrum is identified in the bandwidth allocated to the TV broadcast.

Still another embodiment of the invention is directed to a method for detecting and analyzing signals sensed over a spectrum of width B allocated to the TV broadcast, comprising, comprising: a) acquiring any wireless signals present in the spectrum allocated to the TV broadcast; b) sampling the signals acquired by the antenna unit to provide digitized samples from the low-band signals; and c) analyzing the digitized samples received from the sampler; and d) identifying a piece of unused spectrum in the bandwidth allocated to the TV broadcast by detecting a known signal sequence present in the DTV broadcast according to a respective DTV standards pertinent of the TV broadcast.

Advantageously, the devices and systems according to the invention enable fast scanning of the entire TV spectrum of over 300 MHz, using a system architecture that is easy to use and attractively priced. The devices according to the invention may be used both as independent spectrum detectors or can be integrated in any wireless device.

Another advantage of the invention is that it provides fast scanning of the large spectrum allocated to the primary services, using a plurality of methods and architectures, which may be used independently or may be combined. The invention takes into account the coexistence and collocation requirements set by the FCC les and regulations, for ensuring that the primary services or any emerging services already deployed or which will be deployed in that area are not impacted by the secondary services deployed in the white space identified.

### BRIEF DESCRIPTION OF THE DRAWINGS

The invention is next described with reference to the following drawings, where like reference numerals designate corresponding parts throughout the several views.

FIG. 1 shows the DTV broadcast bands;

FIG. 2 illustrates a block diagram of a WS sniffer according to an embodiment of the invention;

FIG. 3A shows the ATSC transmission spectrum.

FIG. 3B shows the sequences provided in an ATSC signal, which may be used in some embodiments of the invention for identifying the presence of a TV broadcast.

FIG. 4 illustrates a block diagram of the spectrum detector/analyzer of FIG. 2 according to one embodiment of the invention.

FIG. 5 shows an implementation of the method of scanning the TV spectrum that uses the spectrum detector/analyzer of FIG. 4, where the DTV spectrum is divided into two sub-bands.

FIG. 6 illustrates a block diagram of the spectrum detector/analyzer of FIG. 2 according to another embodiment of the invention.

FIG. 7 shows another implementation of the method of scanning the TV spectrum that uses the spectrum detector/analyzer of FIG. 6, where the DTV spectrum is divided into a plurality of sub-bands.

FIG. 8 shows the principle of operation of the ADC according to another embodiment of the invention

FIG. 9A shows an example of wavelet decomposition according to the invention.

FIGS. 10A and 10B illustrate the method of identifying a piece of white space according to an embodiment of the invention, where FIG. 10A shows the method in the presence of a centralized database with channel occupancy information, and FIG. 10B shows the method in the absence of a centralized database with channel occupancy information.

FIG. 11 illustrates the flow chart for the group detection operation according to another embodiment of the invention

FIGS. 12A and 12B show the summary of the ATSC parameters according to the FCC rules.

### DESCRIPTION OF THE EMBODIMENTS OF THE INVENTION

In this specification, the term “primary services” is used for DTV broadcast, wireless microphone and any applications that are entitled by regulations (licensed) to use a specified portion of the spectrum. The term “TV channel” refers to a frequency channel currently defined by a DTV standard. For the illustrative examples used in this specification and without limitation, the specification makes reference to the channels within the VHF and UHF bands as specified by the North America DTV standards. It is to be noted that the invention applies equally to other DTV broadcast systems, such as the European, Japanese, and other DTV systems. The term “piece of spectrum” is used for a portion of the frequency spectrum, and the term “white space channel” is used for a logical channel formed by one or more pieces of spectrum used by a certain white space device for a respective secondary service: it can include a frequency channel or a combination of channels, consecutive or not.

As indicated above, each TV station operating in a certain geographic region/area uses only a limited number of channels from the spectrum allocated to the DTV, such that some parts of the spectrum (contiguous or not) remain unused in the respective area: this locally available spectrum is called “white space”. The term “specified area” or “location” is used to designate a particular area such as single or multi-dwelling units, small office/home office, small businesses, multi-tenant buildings, public and private campuses, etc located in a certain TV market.

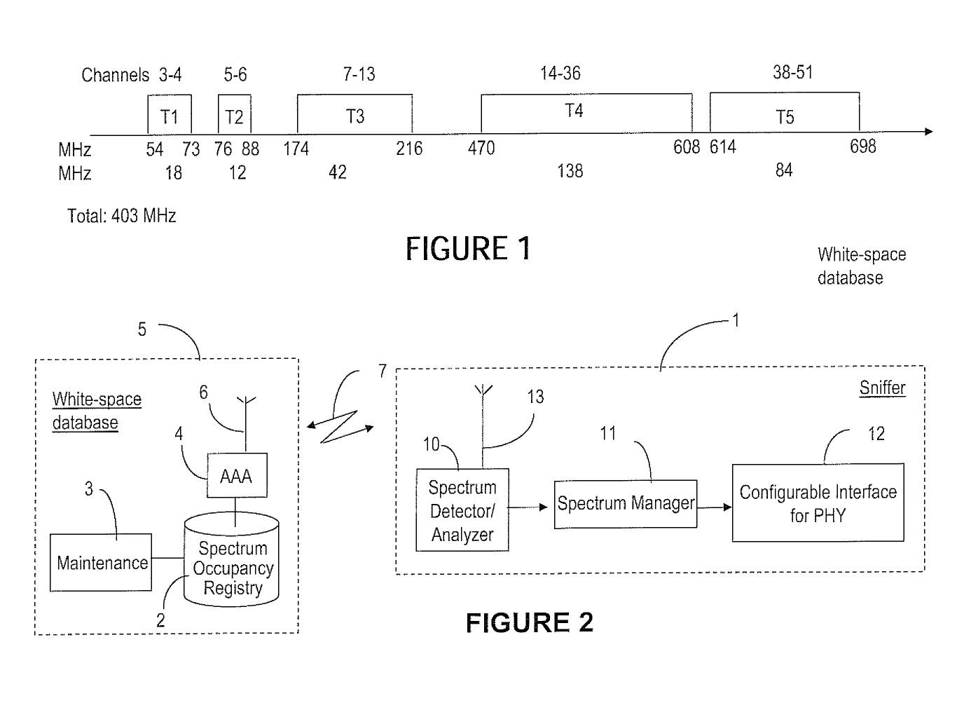

Referring now to the drawings, FIG. 1A illustrates the five bands of the US digital television broadcast spectrum after migration from analog to digital TV broadcast. Band T1, reserved for ATSC channels 2-4 has 18 MHz, extending from 54 MHz to 72 MHz. Band T2 reserved for channels 5-6 has 12 MHz between 76 MHz to 88 MHz, band T3 reserved for channels 7-13 has 42 MHz between 174 MHz and 216 MHz. Further, band T4 carrying channels 14-36 occupies 138 MHz, extending from 470 MHz to 608 MHz and band T5 reserved for channels 38-51 has 84 MHz, from 614 MHz to 698 MHz. Thus, these 49 ATSC channels cover a spectrum of 294 MHz (18+12+42+138+84).

In order to design white space sensors that meet the requirements of the FCC Rules and Orders, the threshold for the sensor sensitivity must be at −114 dBm within the entire width of each 6 MHz of a TV channel, or −107 dBm within a 200 kHz channel normally occupied by a wireless microphone. The FCC proposes minimum 30 seconds for this initial channel availability scanning; a white space device may start operating in that channel if TV broadcast is detected, and also that no wireless microphone or other low power auxiliary operates in the scanned channel during this time interval of 30 seconds. A white space device has also to perform in-service monitoring every 60 seconds.

These FCC specifications pose important challenges for the sensor in terms of the receiver sensitivity, antenna gain, and the sensing and updating rates. Additional challenges are encountered when attempting to detect the wireless microphones: microphone waveforms are analog signals, which could be AM, FM or digitally modulated. Further additional challenges are the out-of-band emissions from other devices and the processing time needed for scanning the spectrum. In principle, this time should be set as a trade-off between using a method of scanning the 6 MHz channels one by one, or scanning multiple channels simultaneously. In the first case, the processing time is quite long, having in view that there are forty-nine 6 MHz channels to be scanned.

A particular challenge is the cost of the device, which should be kept very low in order to obtain an acceptable cost of white space devices equipped with a sniffer. On the other hand, the design of the RF tuner becomes quite complex due to the extent of the spectrum to be scanned. Also, the analog-to-digital converter (ADC) used by the sniffer becomes an issue having in view that the dynamic range of the sensed signals is very high. Thus, the capability to detect a signal as low as −114 dBm requires a dynamic range as high as 140 dB, which results in an 23 bits-ADC. Such an ADC is extremely expensive and rare to find.

The designs currently proposed for the sniffer envisage scanning the 6 MHz channels one-by-one to detect presence of a TV signal, a microphone signal, or any other signals. These currently proposed devices are slowly scanning all 49 TV channels; as discussed above, this arrangement requires an expensive ADC with a dynamic range of 140 dB.

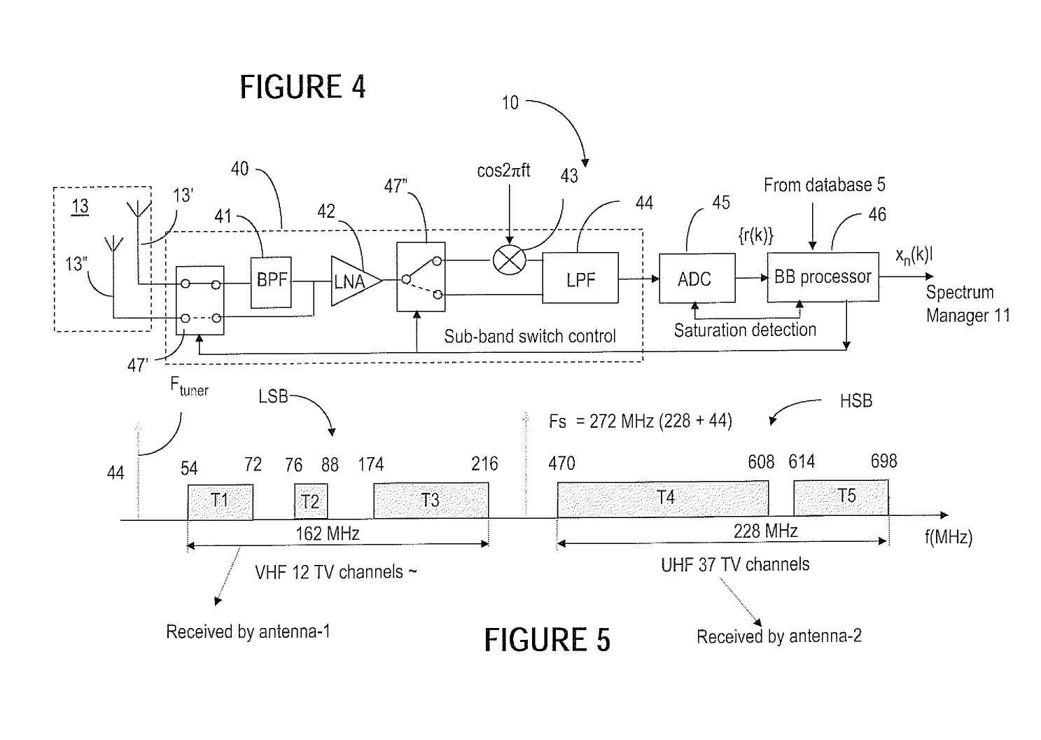

FIG. 2 shows an embodiment of a sniffer 1 according to the invention. The embodiment of FIG. 2 provides an efficient and un-expensive device for economically scanning the spectrum at a particular location and identifying the available white space, in compliance with the FCC Rules and Orders. As shown in FIG. 2, the sniffer 1 includes a spectrum detector/analyzer 10 equipped with sensing antennae 13, a spectrum manager 11, and a configurable interface 12. The particular design of the spectrum detector/analyzer 10 makes it an affordable and reliable addition to any wireless device, as it will be described later in connection with FIG. 4.

The role of the spectrum detector/analyzer 10 is, as the name suggests, scanning the DTV spectrum and detecting pieces of white space. The architecture and operation of this unit is described in further detail in connection with FIGS. 4-7. Interface 12 is configurable, enabling integration of the sniffer with wireless devices of different technologies and functionality.

Based on the spectrum occupancy information collected by detector 10, the spectrum manager (or spectrum planner) 11 identifies the right amount of spectrum for an application of interest. The spectrum manager 11 also reserves the spectrum for the respective application, decides how to use it, and provides the information about the spectrum it reserved to a white-space database 5 via a bidirectional wireless link 7. The design of the spectrum manager 11 takes into account the standard used by the respective air interface used over link 7, and provides the right amount of bandwidth for each application.

FIG. 2 also shown a white-space database unit 5 used for storing and maintaining information about the channel occupancy in the respective area. The database unit 5 includes a spectrum occupancy registry 2, a maintenance module 3 authentication, authorization and access (AAA) module 4, and an antenna 6 used for communicating with any WSD's in the area. Registry 2 maintains information about all DTV channels that are active in the area, and preferably, of all major venues that may organize events where wireless microphones may be used. The registry may also collect and maintain information about the currently active secondary users. This information preferably identifies the respective secondary user, the white space spectrum it occupies, and the time over which each secondary user intends to occupy that channel. Registry 2 may collect and store channel occupancy information provided by the many WSD's performing the sensing in the respective area. Based on this collected information, the database administrator may modify the protection contour for each DTV station, as shown by the maintenance module 3. This is particularly beneficial, since the propagation contour for each DTV station is initially calculated based on a theoretical propagation model, so that it is not accurate and it is beneficial to correct it based on actual measurements in the field. For example, the database administrator may be an Internet Service Provider.

While the channel occupancy information provided by unit 5 is preferably actualized at convenient intervals of time, the white space devices will still need to be equipped with a sniffer for ensuring that indeed the information received from the database is accurate. In one embodiment, the sniffer may also have an added feature enabling it to correct any discrepancies in the information provided by the database. Nonetheless, such corrections need to be closely monitored and double checked so that the corrections to the database are made only if legitimate. This is shown generically by the authentication, authorization and access module 4. As the names implies, module 4 provides authorization to modify the database, so that only certain entities would be able to modify/update the channel occupancy data. The administrator will also have to provide resolution in the cases when the information stored in the spectrum occupancy database 2 is different from the information received from the white space devices operating in the respective area; this is however outside the scope of this invention.

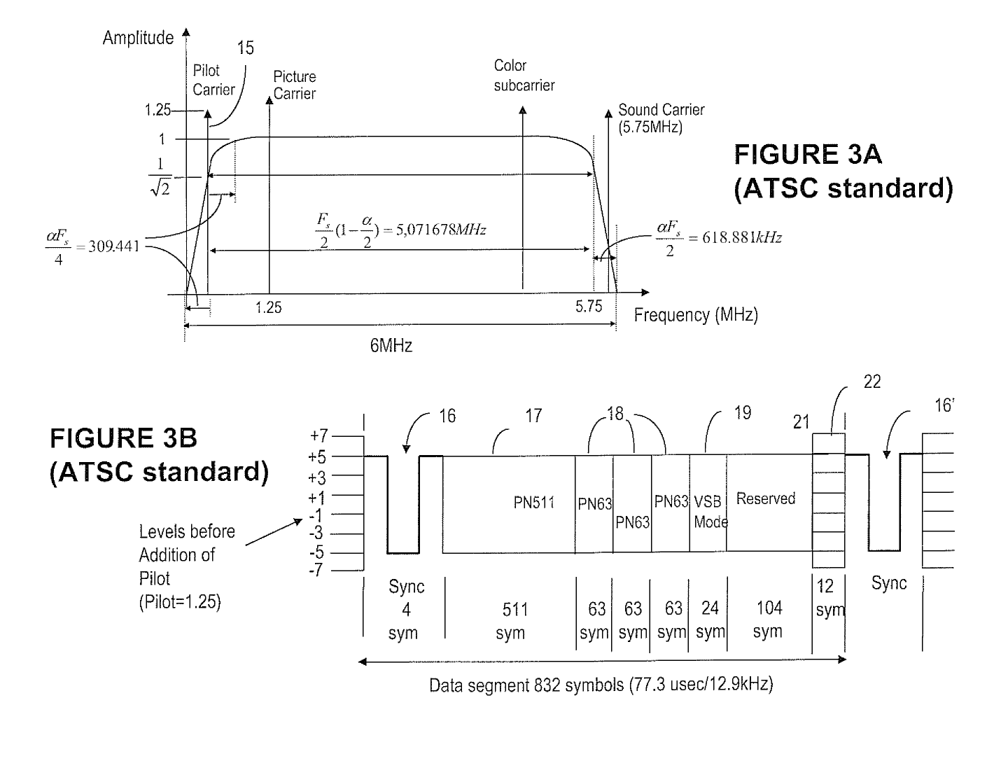

FIG. 3A shows the spectrum and the main characteristics of an ATSC signal, and FIG. 3B shows the data field synchronization sequence used by the ATSC signals. As seen in FIG. 3A, the ATSC signal is allocated a 6 MHz band as for a NTSC signal. However, instead of the Monochrome/Chroma/Audio signal, with three peaks, the spectrum of the DTV signal appears almost like a spread spectrum signal with a raised noise floor, being actually a pseudo spread spectrum type of signal. This is because the DTV signal is actually randomized in order to create a flat noise-like spectrum common with digital signal transmission. This permits maximum channel efficiency and keeps the signal from interfering with nearby channels, so that three HDTV channels can be transmitted right next to each other. A “spike” or “peak” 15 on the lower side of the waveform is called the ATSC pilot, which provides one of three timing signals within the data stream.

The signal is generated from a respectively rasterized image, where only changes or is different from video frame to video frame is transmitted. This digital data is then converted into a high speed 19.39 Mbit/second data stream that is created from an MPEG encoder, and passed to a DTV circuit that takes this 19.39 Mbit signal, adds framing information, and randomizes the data to “smooth” it out. Next the data stream is subjected to Reed-Solomon encoding, which breaks the stream into 207 byte packets, and is further broken into four 2-bit words with built-in error correction using Trellis Convolution encoding. A series of synchronization signals is then mixed with the data stream (Segment Sync, Field Sync, and the ATSC Pilot) and the resulting signal applied to a 8-VSB (8-Level-Vestigal Side Band) modulator which provides the baseband signal. Finally, the baseband signal is then mixed with a carrier signal to “up-convert” it to the desired channel or frequency. The up-converted signal is typically 5.38 MHz wide therefore being confined to within 90% of the 6 MHz channel allocation. To reiterate, the invention is described here for the NA DTV standard, but it can be adapted to any DTV standard.

Each of the resulting MPEG transport packets uses 1 byte (4 symbols) for synchronization, 187 bytes for data (payload) and 20 bytes for FEC, for a total of 828 symbols for the encoded data (3 bits/symbol Trellis coding). For 8-VSN, each symbol pulse has 8 levels, coded using 3 bits (111 or +7; 110 or +5; 101 or +3; 100 or +1; 011 or −1; 010 or −3; 001 or −5; 000 or −7), as shown in FIG. 3B for the example of a synchronization sequence.

FIG. 3B shows a VBS data field synchronization sequence specified for MPEG, which may be used according to the invention to detect presence of a TV broadcast. The packet includes a series of pseudo random noise (PN) sequences for enabling synchronization of the receiver to the transmitted broadcast. There is a first PN sequence 17 of 511 symbols, followed by three PN sequences 18, each 63 symbols long. The PN 63 sequences are inverted on alternative fields. A 24 symbols field provides the VSB mode and 104 symbols are reserved. For enhanced data transmission, the last 10 of the reserved symbols before the 12 precode symbols are defined. The other 82 symbols may be defined for each future enhancement, as needed.

Detection of a DTV signal in the scanned band can be performed in a number of ways. According to one embodiment of the invention, presence of a DTV signal is performed by identifying the PN sequence; the PN sequences can be detected under the noise because they have a repetitive pattern, which distinguished them from the white noise. If such a sequence is identified in a 6 MHz piece of spectrum, it means that that channel is occupied by a DTV broadcast.

In another embodiment of the invention, detection of a DTV channel is based on finding the DTV pilot signal 15 in the scanned spectrum. The pilot 15 based has a constant amplitude (normalized value of 1.25) and is always present at the same place in the 6 MHz spectrum, i.e at the same frequency relative to the beginning of the DTV channel, as seen in FIG. 3A. If for example the DTV signal is denoted with s_{TV}(t), the transmitted signal t_{TV}(t) comprises the s_{TV}(t), and the pilot S_{Pilot}. The signal received by the sniffer, denoted with r(t), includes αs_{TV}(t)+S_{Pilot}, where α is a factor included to account for the impairments introduced by the communication channel. The pilot can be detected for example if the received signal is narrowband filtered and the filtered signal is accumulated a number m of times; m could be for example 1000. This is because s_{TV}(t) takes one of the 8 values +7; +5; +3; +1; −1; −3; −5; or −7 (being an 8-level signal), so that a mean value resulting by accumulating signals of these levels becomes close to zero, while accumulating the pilot, which has always the same amplitude (1.25), results in a detectable level.

According to still another embodiment of the invention, in order to declare a channel as not being occupied, the sniffer first looks for the pilot 15 in each of the DTV channels; if no pilot can be detected, the sniffer looks for a PN-511 sequence 17, and if this is not detected, the sniffer further looks for a PN-63 sequence 18. A channel is free for use by a secondary device if none of the pilot of the PN sequences 17, 18, has been detected in the respective 6 MHz piece of spectrum.

Detecting presence of the wireless microphones (WM) is more complicated, since WM's do not use a pilot signal or any other recognizable sequence, nor do they use a known modulation format. Furthermore, the channel may or may not be snuggled next to a broadcast channel. Thus, most wireless microphones (˜70%) use primarily analog FM modulation for operation in the FM broadcast band of 88-108 MHz, as FCC Part 15 products. Others (about 25%) of these devices are normally for operation in the radio band of 144-148 MHz, but may be re-tuned to 135-175 MHz. The frequency of 146.535 is very popular. The remaining 5 percent use mostly SAW devices around 300 and 400 MHz, and tend to be a bit more expensive. Most wireless microphones occupy a bandwidth of maximum 200 KHz and the signal energy spans over a bandwidth of about 40 kHz (for low and high frequency voice content spectrum). Typical power is at 5 mw or less. In reality, 85% of these units operate at less than 50 mW. The worst-case scenario is when the signal is not modulated (speaker silence), because of the short term carrier drift that may occur during this silence interval. However, even if the FCC rules and orders limit the bandwidth of the wireless microphones to 200 kHz, the TV WBFM microphones may occupy a band as wide as 300 kHz, and have a power output limited to 50 mW in VHF and 250 mW in UHF. In addition, most wireless microphones have a range of about 100 m and the signal energy spans over 40 KHz.

According to an embodiment of the invention, presence of a wireless microphone in a certain part of the spectrum may be detected by measuring the energy accumulated in any 200 kHz piece of spectrum. Similar to the detection of the DTV programming, the detection of wireless microphone signals is performed over an entire DTV channel (6 MHz), in chunks of 200 kHz, using a raster frequency of 50 MHz. In other words, the received signal r(t) is filtered into 200 kHz chunks r′(t), and then sampled to obtain samples {r′(k, Δt)}. The energy of the accumulated samples Σ|r′(k, Δt)|² is compared with a threshold to then identify presence of a microphone signal. The sniffer detection threshold considered in this specification is −107 dBm within 200 kHz; accumulated energies less than −107 dBm indicate absence of a microphone signal, while accumulated energies higher than 107 dBm indicate the presence of a microphone signal.

It is apparent that scanning the entire DTV band requires an analog to digital converter with a very large dynamic range. The present invention provides solutions for addressing this problem, as described next.

FIG. 4 is a block diagram of an embodiment of the spectrum detector and analyzer 10 of FIG. 2. Spectrum detector/analyzer 10 is a passive device, which detects the available spectrum based on specific signal features, preferably using wavelets. As far as detecting presence of DTV signals, device 10 is able to detect the TV pilot signal or/and the PN-511 and PN-63 fields normally transmitted on each active DTV channel. Based on the combined detection of these three known sequences, the sniffer determines whether the TV channel is occupied or not. Thus, if the spectrum analyzer 10 does not detect any of the pilot 15 or sequences 17 and 18 in a scanned channel, it concludes that the respective 6 MHz channel is free and can be used by a respective secondary system. On the other hand, if detector/analyzer 10 detects one of the pilot 15 or a sequence 17, 18, it means that the channel is occupied by a primary service. It is to be noted that even in the presence of a white space database 5 that provides spectrum occupancy information, it is good practice to use the sniffer for detecting if indeed the information provided by the database is correct.

Spectrum detector/analyzer unit 10 of FIG. 4 includes a VHF/UHF antennae unit 13, a down-conversion unit 40, an analog to digital converter (ADC) 45 the filters for shaping the signal and a baseband processor 46. Antennae 13 may be the device antenna, or may be provided as a separate antenna optimized both in resonant frequency and size. FIG. 4 illustrates two antennae 13, 13′, each optimized for a certain resonant frequency, as seen next.

As indicated above, scanning such a large part of the spectrum requires an ADC with a very large range (140 dBm), which makes it expensive and unsuitable as an addition to any wireless device. The invention provides for a number of solutions to address this problem. Thus, according to one aspect of the invention, spectrum analysis is performed successively over a number of sub-bands, and the analyzer is adapted to scan these sub-bands using the same ADC 45. This is enabled by the down-conversion unit 40, which down-converts the signals received from the antenna unit to low-band signals of a narrower bandwidth, so that the differences in the power of the signals in the narrower band would most probably be less than the differences in the power of signals present in a wider band. In the general case, band B may be divided into n sub-bands, where n≧1; in the example of FIG. 4, the entire band B occupied by the TV broadcast is divided into two sub-bands (n=2), a lower sub-band designed with LSB and a higher sub-band designed with HSB, as shown in FIG. 5. The lower sub-band covers the spectrum between 54 MHz and 216 MHz, which includes 12 VHF TV channels extending over 162 MHz. The higher sub-band covers the spectrum between 470 MHz and 860 MHz, which includes 37 UHF TV channels extending over 228 MHz. As also discussed above, the sniffer may be provided with two antennae, one for each sub-band.

In the embodiment of FIG. 4, down-conversion unit 40 includes a band-pass filter (BPF) 41, a linear amplifier (LNA) 42, a tuner 43, a low-pass filter (LPF) 44 and a switching block 47. The switching block 47 includes switches 47′ and 47″. When lower sub-band LSB is scanned, the BPF 41 and tuner 43 are excluded from the signal path, so that ADC 45 samples the signals in the 54-216 MHz sub-band. When higher sub-band HSB is scanned, the BPF 41 and tuner 43 are included in the signal path. In this case, the signals in the higher sub-band are down-converted to frequencies substantially similar to these of DTV channels 1-12, so that both signals in the upper and lower bands can be sampled with the same sampler 45. It is apparent that the cost of sampler 45 is significantly reduced by using a single ADC for both LSB and HSB.

In this way, the ADC 45 samples signals over a maximum 228 MHz band, rather than over the entire TV spectrum of over 400 MHz. Sampling the signals in both sub-bands with the same ADC 45, enables use of an ADC 45 with an acceptable dynamic range. The sampling frequency Fₛ is selected for example at 272 MHz, which is higher than the highest frequency in the lower band and the down-converted higher band. In this way, the signals are completely determined as per the Nyquist-Shannon sampling theorem, and can be recovered correctly.

FIG. 5 shows the two sub-bands, the tuner frequency of 44 MHz and the sampling frequency of 272 MHz. It is to be noted that the tuner frequency is selected at 44 MHz as an example; other tuner frequencies Fₜ can equally be used, as long as both sub-bands do not have frequency components higher than 228+Fₜ.

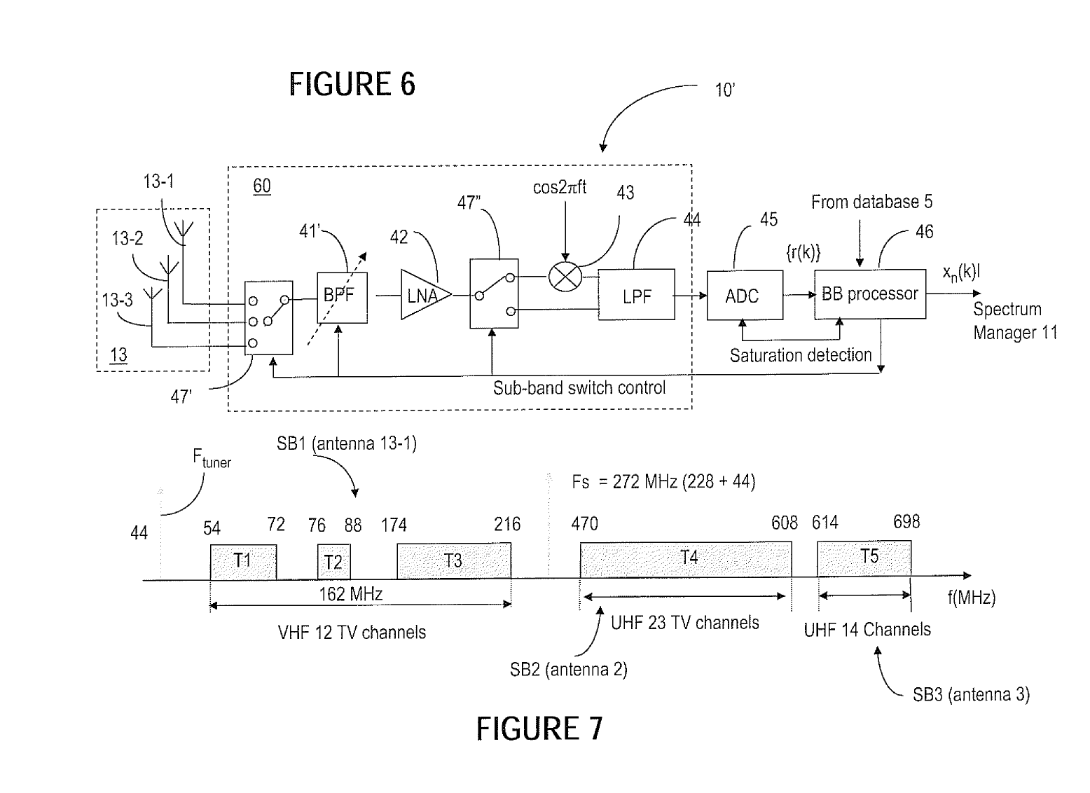

It is also to be noted that the spectrum of interest may be divided into more than two sub-bands, in which case the embodiment of FIG. 4 will have an adequate number of branches before the ADC. Such an embodiment is shown in connection with FIGS. 6 and 7, where FIG. 6 shows the block diagram of an example where scanning of the DTV spectrum is performed over three bands, and FIG. 7 shows how the bands are selected for this example.

In the embodiment of FIG. 4, the BPF 41 has a bass-band of 228 MHz to pass all 37 TV channels in the HSB to the LNA 42. The LPF 44, which is common for both HSB and LSB signals, has a maximum frequency of 272 MHz, so that all signals in the LSB and the down-converted signals from the HSB are passed to ADC 45. At the output of filter 44, the ADC 45 samples signals present over a maximum 228 MHz band. By sampling the signals in both sub-bands with the same ADC 45, enables use of an ADC 45 with an acceptable dynamic range. The sampling frequency Fₛ is selected for example at 272 MHz, which is higher than the highest frequency in the lower band and the down-converted higher band. In this way, the signals are completely determined as per the Nyquist-Shannon sampling theorem, and can be recovered correctly.

The signal at the output of the LPF 44 is sampled by the analog to digital converter 45. In this example, ADC 45 has a sampling rate (Nyquist-Shannon) of 2×272 MHz and operates at 8 bits per sample. Baseband processor 46 processes the data signal and provides the processed samples to the spectrum manager 11. According to this embodiment of the invention, the BB 46 controls the sub-band switching by including the tuner and the BPF in the signal path or not, depending on the sub-band scanned.

FIG. 6 illustrates a block diagram of the spectrum detector/analyzer of FIG. 2 according to another embodiment of the invention, where the DTV band is divided into three sub-bands. FIG. 7 shows how the spectrum is divided for scanning using the detector/analyzer 10′ of FIG. 6.

Spectrum detector/analyzer unit 10′ of FIG. 6 further reduces the dynamic range of the ADC by dividing the DTV band into three sub-bands SB1, SB2 and SB3 n−3) as shown in FIG. 7. In this embodiment, SB1 extends over 162 MHz between 54 MHz and 216 MHz, occupying 12 VHF TV channels. SB2 extends over 138 MHz in the lower part of the UHF band between 470 MHz and 608 MHz, occupying 23 DTV channels. SB3 extends over 84 MHz in the upper part of the UHF band between 614 MHz and 698 MHz, occupying 14 DTV channels. Antenna unit 13 is equipped with three antennae in this example: a first antenna 13-1 is used for SB1, a second antenna 13-2 is used for SB2 and a third antenna 13-3, for SB3. The down-conversion unit 60 include a tunable band-pass filter (BPF) 41′, optimized to operate in the respective three sub-bands. Switch 47′ shows generically how the antennae 13-1 to 13-3 are switched when the respective sub-band is scanned. As for the embodiment of FIG. 4, unit 10′ also includes a linear amplifier (LNA) 42, a tuner 43, a low-pass filter (LPF) 44, ADC 45 and a baseband processor 46. In this embodiment, signals detected in all three sub-bands are sampled using the same ADC 45. When SB1 is scanned, the BPF 41′ is adjusted for this band and tuner 43 is excluded from the signal path as shown generically by switch 47″. The ADC 45 now samples the signals in the 54-216 MHz sub-band SB1. When sub-bands SB2 and SB3 are scanned, BPF 41′ is tuned accordingly and tuner 43 is included in the signal path by switch 47″. In this case, the signals in sub-bands SB2 and SB3 are down-converted to frequencies substantially similar to these of SB1, so that all signals in the lower band and upper bands can be sampled with the same sampler 45. It is apparent that the complexity of the sampler 45 is significantly reduced by using this arrangement.

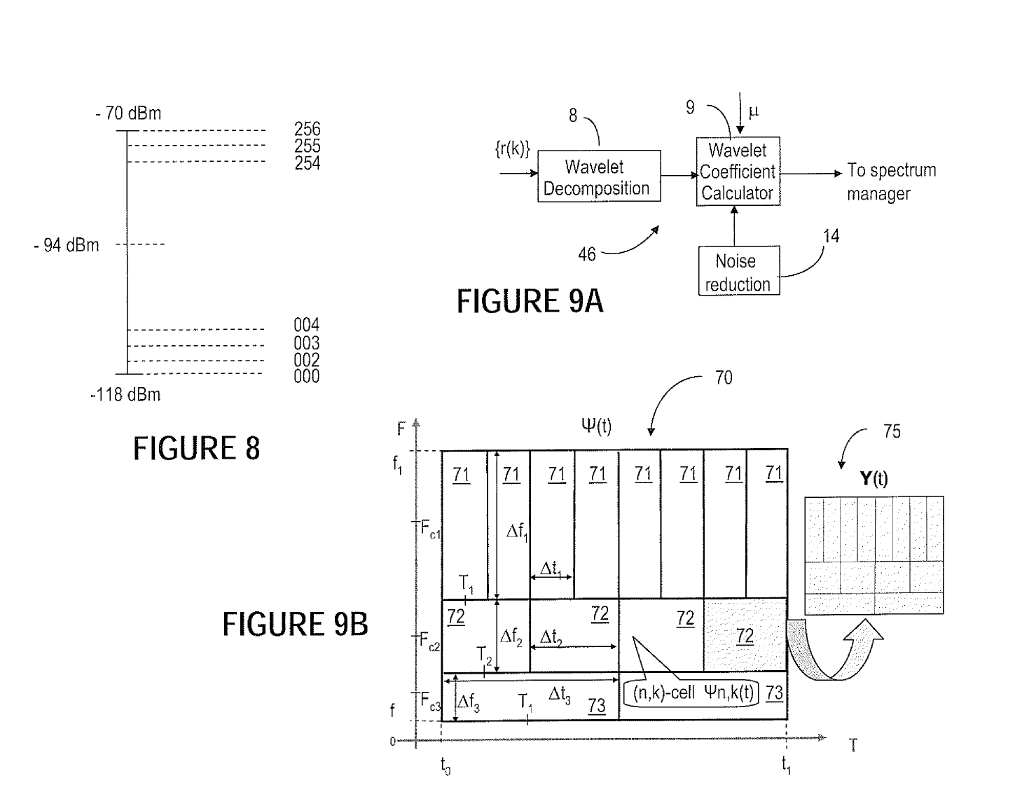

FIG. 8 shows the operation of the ADC according to another embodiment of the invention. As discussed above, FCC rules and regulations require a very high range over which signals have to be sensed for presence of primary services (i.e. strong DTV signals and weak wireless microphone signals); this range is about −118 dBm. According to the invention, it is possible to use an ADC with a dynamic range of 50 dBm if all signals stronger than a pre-selected level are cut-off (clipped). For example, if the cut-off level is selected at −70 dBm (signals stronger than −70 dB are cut-off), the range over which the ADC needs to operate is significantly reduced to 118 dBm −70 dBm=48 dBm. This can be obtained by setting the operating point of the ADC at about −94 dBm and by operating the ADC in saturation for signals stronger than 25 dBm under or over the −94 dBm level. It is apparent to a person skilled in the art that other cut-off levels can be also used, and that the −70 dBm level is selected by way of example; the specification will use the generic term “cut-off threshold” for this value.

This mode of operation of the ADC 45 enables reducing the processing time in that the sniffer can detect fast if a certain piece of spectrum is used by another service, with a good probability. When all samples of the received signal within a scanned piece of spectrum over a preset amount of time are constant and at the cut-off threshold, the BB processor 46 determines that the ADC works in saturation, and concludes that the respective channel is occupied. When all the sensed samples of the received signal are under the cut-off threshold, BB processor 46 decides that a primary service may or may not occupy the respective piece of spectrum and begins applying other sensing methods, as described later.

As discussed above, presence or absence of a primary service is determined based on measurement of the energy in the respective part of the spectrum, by scanning the spectrum in multiples of 6 MHz for the DTV broadcast, and then scanning a certain piece of 6 MHz identified as unused by the DTV in chunks of 200 Khz for detecting presence of any active wireless microphone. It is apparent that scanning the entire DTV band in this way may require a long time. To address this problem, the BB processor 46 uses a grouped detection algorithm and preferably wavelet signal analysis (alternatively a well known FFT—Fast Foruier Transform) for determining signal energy. Use of wavelet signal analysis speeds-up the energy detection process. The advantage of the wavelet signal analysis resides in the fact that the waveform of the wavelets (the energy) can be adjusted both in time and frequency to fit into a piece of spectrum of a certain size, and then the energy of the signals in the respective piece of spectrum can be measured and analyzed against thresholds. The waveforms can be selected to be very narrow in time duration so that they may be used to measure the energy high bandwidth transmissions.

The scope of the wavelet analysis according to this invention is to identify frequency-time pieces of spectrum (called frequency-time “cells”) with little or no detectable signal activity, which can by used by the secondary services. As seen in FIG. 9A, the baseband processor 46 includes in general terms a wavelet decomposition unit 8, a wavelet coefficients calculator 9 and a noise reduction unit 14. Wavelet decomposition unit 8 “decomposes” the received signal over frequency-time cells, by creating mother and daughters wavelets as shown in FIG. 9B. Wavelet coefficient calculator 9 determines the wavelet coefficients which provide information about the energy of the signal in the analyzed time-frequency cell. The wavelet coefficients are then compared against energy thresholds μ; the channels that have the coefficients under the threshold define a piece of white space. The spectrum manager 11 receives the information about the time and frequency coordinates of the respective piece/s of white space and disposes of this information as needed.

The basic background information on wavelet functions as used in the embodiments according to this invention is provided in the above-identified co-pending patent application Ser. No. 12/078,979, entitled “A System and Method for Utilizing Spectral Resources in Wireless Communications” (Wu et al) filed Apr. 10, 2008, Ser. No. 12/078,979, which is incorporated herein by reference. A brief description of how the wavelets operate is provided in connection with FIG. 9B. A wavelet is generated from a single mathematical function (ψ (t)) called a “mother” wavelet, which is a finite-length or fast-decaying oscillating waveform both in time and in frequency. The wavelet function is denoted with ψ_{α,τ}(t) and the corresponding frequency domain representation is denoted with \hat{Ψ}_{α,τ}(ω), where α represents the scaling parameter of the wavelet waveform, while τ represents the shifting or translation parameter of the wavelet waveform. “Daughter” wavelets are scaled (by a factor α) and translated (by a time τ) copies of the mother wavelet.

The wavelet function ψ_{α,τ}(t) used in this invention is selected such that 99% of the wavelet energy is concentrated within a finite interval in both the time and frequency domain. In addition, the wavelet function ψ_{α,τ}(t) is selected so as to enable integer shifts (translations) of its concentration center, such that adjacent shifted waveforms ψ(t−τ) may be generated to form an orthogonal basis for energy limited signal space. Changes in the scaling parameter affect the pulse shape; if the pulse shape is dilated in the time domain, it will automatically shrink in the frequency domain. Alternatively, if the pulse shape is compressed in the time domain, it will expand in the frequency domain (f axis). The shifting parameter τ represents the shifting of the energy concentration center of the wavelet waveform in time. Thus, by increasing the value of the translation parameter τ, the wavelet shifts in a positive direction along the t axis; by decreasing τ, the wavelet shifts in a negative direction along the t axis.

As shown in FIG. 9B, the communication spectrum of interest (for example the spectrum allocated to the DTV) is divided into a frequency and time map 70 having a plurality of frequency time cells 71, 72, 73. Each frequency-time cell within the frequency and time map constitutes at least one “channel”. The wavelet waveform characteristics may be manipulated to process frequency-time cells of different granularity and thus identify pieces of white space within the frequency and time map 70. As indicated above, changes to the scaling and translation parameters enable the frequency and time map 70 to be divided according to a variable/desired time-frequency resolution

For example, by setting the scaling parameter to a first value and incrementing the translation parameter, a plurality of cells 71 having a bandwidth of Δf₁ and a time slot interval of Δt₁ are provided. By setting the scaling parameter to a second value and incrementing the translation parameter, a plurality of cells 72 having a reduced bandwidth of Δf₂ and an increased time slot interval of Δt₂ are provided. Still further, by setting the scaling parameter to a third value and incrementing the translation parameter provides a plurality of cells 73 having a further reduced bandwidth of Δf₃ and a further increased time slot interval of Δt₃. As also illustrated in FIG. 7B, using the wavelet function, each cell within the frequency and time map 70 may be further divided into frequency and time cells according to another frequency and time map 75. For example, right hand cell 72 may be further divided into frequency and time cells based on another wavelet function Y(t), and so on.

After wavelet decomposition, wavelet coefficient calculator 9 (see FIG. 9A) calculates the wavelet coefficients w_{p,q} of the digitized signals, which coefficients reflect the signal energy in the respective time-frequency cell:

w_{n,k}=∫r(t)ψα_{p,q}(t)

where ψ_{n,k}(t) is the wavelet function, with n and k integers selected as a function of the scaling parameter α and the translation parameter τ. In the above referenced co-pending patent application, p and q are defined as follows: α=b^{p} and τ=qb^{p}, where b is a positive rational number (e.g., 1.2, 2, 2.1, 3, etc.) and p and q are integers (e.g., 0, +/−1, +/−2, +/−3, etc.).

The calculated wavelet coefficients w_{p,q} are then used to determine the signal energy in the respective time-frequency cell comparing the signal energy corresponding to each detected signal to an energy threshold η, and the respective piece of white space is selected if the detected energy is under the threshold:

|w_{p,q}|²≦μ

where μ is a predefined positive number representing the threshold for the energy level. The predetermined threshold level μ may be pre-set, or may be configured to vary depending on the spectrum being scanned, the acceptable interference level, signal power, etc.

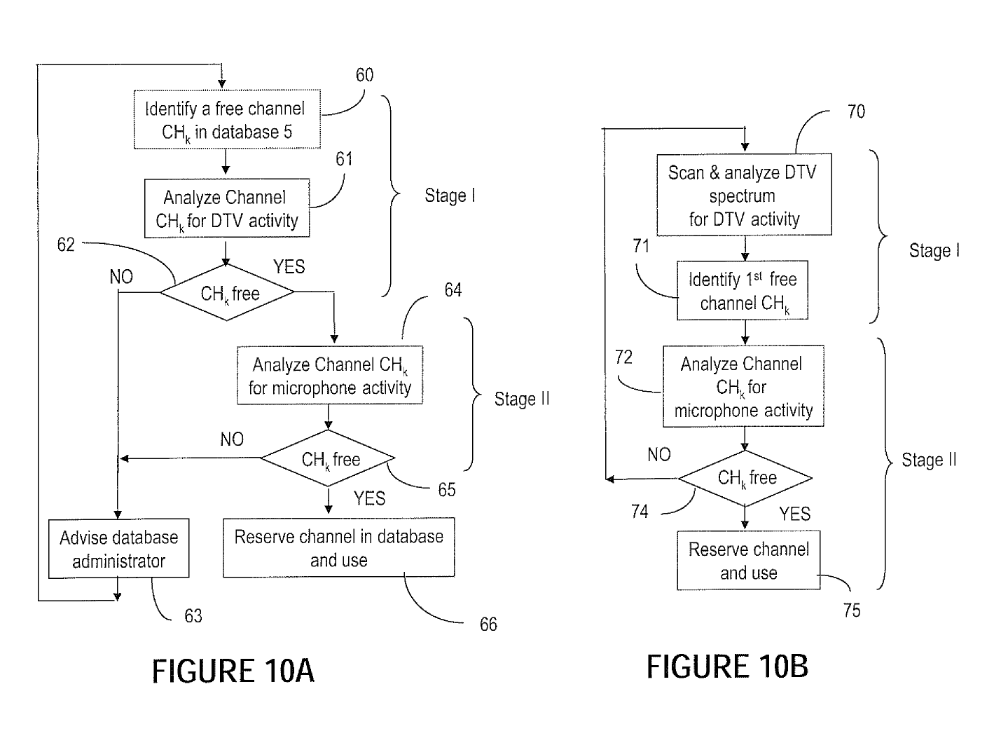

FIGS. 10A and 10B illustrate the method of identifying a piece of white space according to an embodiment of the invention, where FIG. 10A shows the method in the presence of a centralized database with channel occupancy information, and FIG. 10B shows the method in the absence of a centralized database with channel occupancy information. As seen in FIG. 10A, in the presence of a database 5, unit 10 identifies a free channel CHₖ in the database, step 60. The sniffer preferably uses a resolution equal to the width of a DTV channel (6 MHz in NA) for identifying pieces of white space of that size or multiple thereof. In addition, when the resolution is the width of a DTV channel, the information provided by the database 5 is easier to use; the channels that are identified in the database as occupied may be skipped to reduce the processing time. It is also to be noted that in the case that the application of interest requires a bandwidth larger that offered by one DTV channel, the sniffer will select a number of consecutive channels indicated as free in the database (not shown). Spectrum detector/analyzer 10 then scans the selected channel/s and processes the signals sensed in two stages, using a different resolution in each stage. In the first stage, the sniffer proceeds with verifying if indeed the channel/s is/are free, step 61, by performing a wavelet transform of the received signal using a time frequency cell of choice. For example, the frequency variable of the wavelet transform function for the first stage may cover the entire width of the DTV channel (6MHz in North America). If the sniffer identifies a DTV signal in the selected channel/s, branch NO of decision block 62, it advises the database of this event and returns to step 60 to select another free channel.

If, on the other hand the sniffer determines that there is no DTV broadcast signal in CHₖ, branch YES of decision block 62, the channel is further analyzed during a second stage to detect presence of any wireless microphone signals, step 64. The channel is reserved for an application of interest if indeed the sniffer confirms that CHₖ is free, steps 65, 66. If presence of a microphone signal is detected, the database administrator is advised and the sniffer repeats steps 60-65 for another channel identified as free in the database. It is to be noted that channel CHₖ may still be used if the respective application requires use of only a part of this channel, in which case step 64 analyzes the channel accordingly, using a time-frequency cell size selected based on the size of the bandwidth needed for the respective application (not shown).

As seen in FIG. 10B, when no database is available, during the first stage the sniffer scans and analyzes the spectrum allocated to the DTV, step 70, using preferably a resolution equal to the width of a DTV channel (6 MHz in NA) for identifying pieces of white space of that size or multiple thereof. As in the method described with reference with FIG. 10A, the granularity for the time-frequency cells may also be selected in accordance with the bandwidth required for an application of interest. However, a granularity conforming to the size of a DTV channel is preferred since it enables a more deterministic processing of the signals in the respective piece of spectrum, as a DTV channel may be identified by looking for known sequences (pilot, PN 511, PN-63) described in connection with FIG. 3B. However, if another granularity is selected for signal processing, saturation of the ADC 45 may be used for detecting if the piece of spectrum of interest is free.

The first processing stage stops once a piece of 6 MHz is found, step 71, where the signal energy is under the threshold μ, indicating that piece of spectrum is not used for DVT transmission. The channel identified in step 71 is denoted with CHₖ. During a second stage, the sniffer has to check if there is any wireless microphone operating in CHₖ, step 72. Now, it has to process the signals in the piece of spectrum identified in the first stage with a resolution of 200 kHz. Preferably, the signals are processed starting at a frequency that is a multiple of 50 kHz. If CHₖ identified in step 71 turns out to be free, as shown by branch YES of decision block 74, the sniffer reserves CHₖ for the respective application, step 75. If no piece of white space of the required bandwidth can be identified in CHₖ due to the presence of one or more wireless microphone signals, as shown by branch NO of decision block 74, operation of the sniffer resumes with step 70.

According to another aspect of the invention, the detection process may be enhanced using a wavelet noise reduction procedure, illustrated generically by unit 14 on FIG. 9A. According to this procedure, the channel noise is estimated using any known method of mean variance estimation, with a view to determine the threshold μ with a certain reliability. If the transmitted signal is denoted with s(t), the received signal is denoted with r(t), and the noise with N(t), after the wavelet transform of the signal, the wavelet coefficient is a vector of the form:

$$\begin{matrix}[ \begin{matrix}r ( 0 ) \\ r ( Δ t ) \\ ⋮ \\ ⋮ \\ r ( k , Δ t ) \\ ⋮ \\ r ( M , Δ t )\end{matrix} ] = [ \begin{matrix}s ( 0 ) \\ s ( Δ t ) \\ ⋮ \\ ⋮ \\ . s ( k , Δ t ) \\ ⋮ \\ s ( M , Δ t )\end{matrix} ] + \\ [ \begin{matrix}N ( 0 ) \\ N ( Δ t ) \\ ⋮ \\ ⋮ \\ N ( k , Δ t ) \\ ⋮ \\ N ( M , Δ t\end{matrix} ] wT [ \begin{matrix}r ( 0 ) \\ ⋮ \\ ⋮ \\ r ( M , Δ t )\end{matrix} ] \\ = wT α [ \begin{matrix}s ( 0 ) \\ ⋮ \\ ⋮ \\ s ( M , Δ t )\end{matrix} ] + wT [ \begin{matrix}N ( 0 ) \\ ⋮ \\ ⋮ \\ N ( M , Δ t )\end{matrix} ]\end{matrix}$$

where wT denotes a wavelet transform, k is the sample number, M is the maximum number of samples, Δt is the distance between two consecutive samples (time) and α accounts for the impairments introduced by the channel between the transmitter and the receiver. The received baseband signal after the wavelet transform becomes:

$$[ \begin{matrix}{r}^{′} ( 0 ) \\ ⋮ \\ ⋮ \\ {r}^{′} ( M , Δ t )\end{matrix} ] = α [ \begin{matrix}{s}^{′} ( 0 ) \\ ⋮ \\ ⋮ \\ {s}^{′} ( M , Δ t )\end{matrix} ] + [ \begin{matrix}{N}^{′} ( 0 ) \\ ⋮ \\ ⋮ \\ {N}^{′} ( M , Δ t )\end{matrix} ]$$

The noise can be reduced now in the decomposed signal by resetting the wavelet coefficients to zero W_{n,k}=0 if the corresponding signal component is inferred to be statistically ignorable. As indicated above, the wavelet transform function is selected so as to concentrate the energy of a signal within 99% of the respective time-frequency cell. According to the property of the transmitted signal s(t), if the wavelet coefficient w(k) has a value that is significant with respect to the noise standard deviation σ, this means that the channel is in use. If there is no signal in the respective piece of spectrum, the wavelet coefficient w(k) of the received signal is very small (close to zero), in which case w(k) will be at the noise level, i.e. comparable to the σ of the noise floor.

For the second case (w(k)<<σ), the wavelet coefficients are reset using the noise information and the signal is reconstructed using the inverse wavelet transform with the new wavelet coefficients u(k), after the received signal wavelet coefficient resetting. The reconstructed signal is then further processed using the detection methods described above (pilot or PN detection, etc). This noise reduction procedure is beneficial in that it “cleans” the signal from noise so that a more accurate detection can be performed.

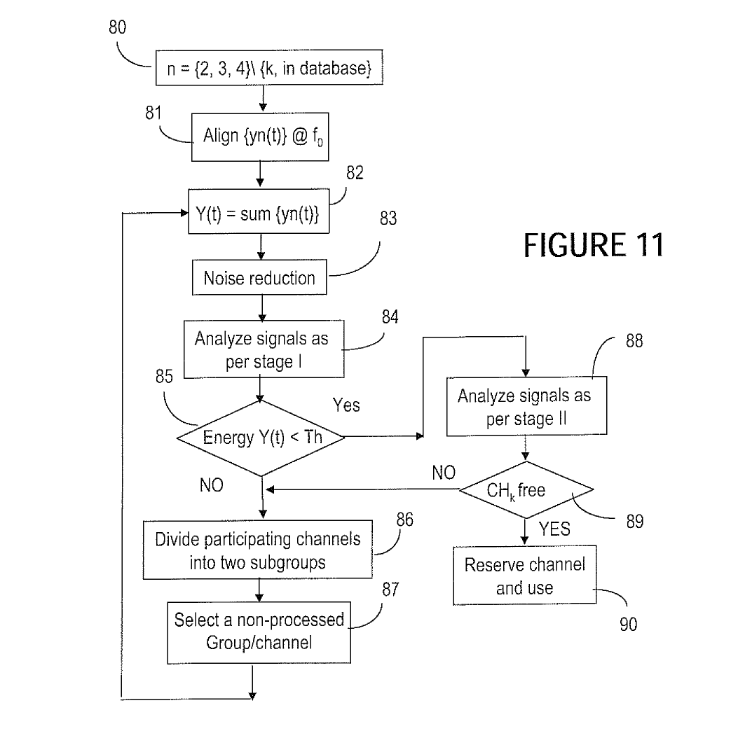

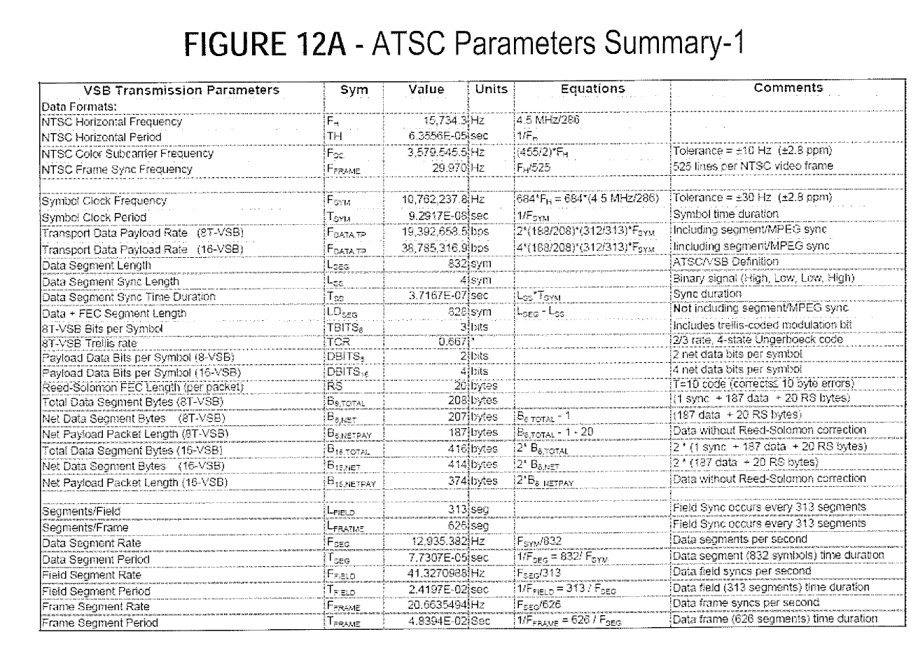

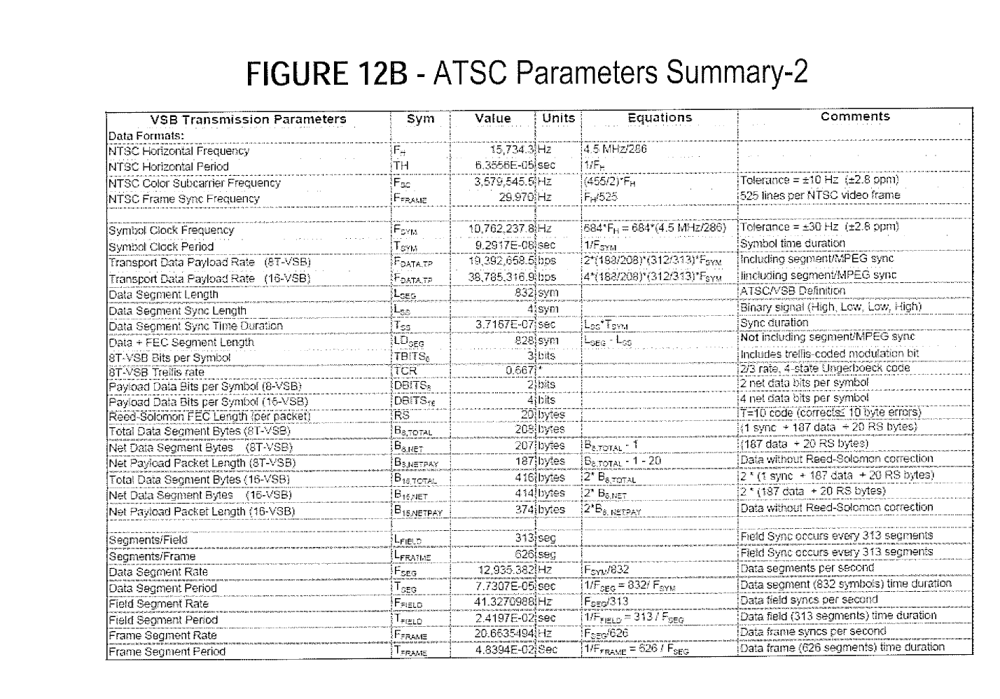

The two stage process described in connection with FIGS. 10A and 10B can be time-consuming even if the overall process is faster than the traditional methods of repetitive averaging and filtering. This two-stage process may be accelerated using a group detection procedure according to the invention, as shown in FIG. 11. For the group detection procedure, the sniffer processes a group of DTV channels in the first stage. The channels are preferably consecutive and the channels identified in the database 5 as occupied are not included in the group, as shown in step 80. Alternatively, the sniffer may nonetheless include these channels in the group. The signal at the output of ADC 45 is denoted with {r(k)}, where k is the sample number. After baseband processing and wavelet decomposition of {r(k)}, the signal in a certain channel (or cell) is denoted with {xₙ(k)}, where n is the number of the channel. The signal in each channel is then low-passed to align signals from all channels at an origin frequency of zero, as shown in step 81, to get channelized data for each channel at Nyquist rate, denoted with {yₙ(l,Δt)}.

The channelized data from the channels in the group are over-lapped next, to obtain the sum of these signals:

Y(t)=Σ[y₁(t)+y₂(t)+yₖ(t)+y_{G}(t)+N]

This is shown in step 82. A noise reduction operation may be performed on the overlapped signal, as described above and shown in step 83. The energy E of the summed signal is then calculated after noise reduction, step 83. Namely, the BB processor 46 performs the first stage of the method, described in connection with FIG. 10A or 10B, as shown by step 84. For example, the BB processor 46 attempts to identify the pilot or the PN sequences in the signal, shown in step 84. If the energy of the received signal is less than a threshold (for example E<−70 dBm), branch ‘Yes’ of decision block 85, a signal may still be present in that group of channels or channel, and the processor perform stage I of the method shown in FIG. 10A or 10B for detecting presence of any wireless microphone in that piece of spectrum.

If the energy of the signal is higher than the threshold, for example is E≧−70 dBm, branch ‘No’ of decision block 85, it means that one or more of the channels in the group may be occupied. In this case, the group detection procedure is repeated for a subgroup of channels from the group (e.g. half of the channels in the group), which were not processed yet, steps 86, 87. Then again, the sum of the channelized data in the respective sub-group is determined in step 82 and the procedure is repeated until a free channel is detected, when the stage II is performed.

Operations along branch “Yes” of the decision block 85 are performed when the energy of the signal is smaller than the threshold. In this case, the system tries to identify if channel from the group without any wireless microphone signals, as shown by steps 88, 89. The first such channel is reserved for the respective secondary service, step 90. If no channel in the group is free, then the group detection procedure is repeated for a subgroup of channels from the group, as shown by steps 86 and 87

Detecting DTV signals may also be performed by overlapping in time data segments from multiple channels so that after a certain number of summations the pilots add-up, while the data averages at a value close to zero over the consecutive summations (since the data is random). In this case, both the pilot and the PN sequences in the channels where a DTV signal is present are added, resulting in a level that is easier to detect over noise.

Other methods of detecting the presence of a wireless microphone may be used according to the invention; this are performed only on TV channels detected as unused using any of the above methods. For example, wavelet decomposition may still be used, and the pieces of white space with the largest wavelet coefficients are selected. The signals in these channels are accumulated a specified number of times. Next, a 2 k FFT decomposition is performed on the received signal and by measuring the energy on each bin; comparing the peaks with noise floor enables processor 46 to determine whether a wireless microphone signal is present or not.

The embodiments of the invention described above are intended to be exemplary only and not a complete description of every possible configuration of any system or method for proactive repeat transmission of data units sent using an unreliable network service. The scope of the invention is therefore intended to be limited solely by the scope of the appended claims.

We claim:

1. A white space spectrum sensor for enabling implementation of a secondary service application from a wireless device, comprising:
a spectrum detector/analyzer for identifying a piece of white space spectrum of a specified width;
a spectrum manager for establishing the specified width based on requirements of the secondary service application and reserving the piece of white space spectrum for the secondary service application; and
a configurable interface for enabling integration of the sensor with the wireless device.

2. A white space spectrum sensor for enabling implementation of a secondary service application at a wireless device, comprising:
a spectrum detector/analyzer for analyzing a piece of spectrum of a specified width to confirm that the piece of spectrum is not occupied;
a spectrum manager for establishing the specified width based on requirements of the secondary service application and reserving the piece of spectrum for the secondary service application; and
a configurable interface for enabling integration of the sensor with the wireless device.

3. A sensor as claimed in claim 2, wherein the spectrum manager updates a white space database with the information regarding the piece of spectrum reserved for the wireless device.

4. A sensor as claimed in claim 2, wherein the spectrum manager retrieves information about the piece of spectrum from a white space database that maintains spectrum occupancy information for a TV market of interest.

5. A spectrum detector/analyzer for detecting and analyzing signals present in the spectrum of a band B allocated to the TV broadcast, comprising:
an antenna unit for acquiring wireless signals present in band B;
a sampler for digitizing the signals acquired by the antenna unit to provide digitized samples; and
a baseband (BB) processor for analyzing the digitized samples and identifying a piece of unused spectrum in the bandwidth allocated to the TV broadcast by detecting a known signal sequence present in the DTV broadcast according to a DTV standard pertinent to the respective TV broadcast.

6. A spectrum detector/analyzer as claimed in claim 5, wherein the known signal sequence is the DTV pilot.

7. A spectrum detector/analyzer as claimed in claim 5, wherein the known signal sequence is a pseudo random sequence.

8. A spectrum detector/analyzer for detecting and analyzing signals sensed over a spectrum of width B allocated to the TV broadcast, comprising:
an antenna unit for acquiring wireless signals present in n sub-bands established over the spectrum allocated to the TV broadcast, a sub-band SBₖ having a certain width Bₖ where k ε[1,n] and n≧1;
a down-conversion unit for down-converting the signals received from the antenna unit in each sub-band SBₖ to low-band signals extending over a low-band of width Bₖ;
a sampler for sampling the low-band signals in each sub-band to provide digitized samples from the low-band signals; and
a baseband processor for analyzing the digitized samples received from the sampler and identifying a piece of unused spectrum in the bandwidth allocated to the TV broadcast.

9. A spectrum detector/analyzer as claimed in claim 8, wherein the baseband processor selects the width Bₖ of each sub-band SBₖ.

10. A spectrum detector/analyzer as in claim 8, wherein the down-conversion unit comprises:
a tunable band-pass filter for filtering-out the sensed signals outside of sub-band SBₖ;
a tuner for down-converting the signals in the sub-band SBₖ into low-band signals occupying a low band of width Bₖ; and
a switching block for configuring the antenna unit, the band-pass filter and the tuner to process accordingly the signals of the sub-band SBₖ under control of a sub-band switch control signal.

11. A spectrum detector/analyzer as claimed in claim 10, wherein the tuner frequency Fₜᵤₙₑᵣ is selected in accordance with the width of the specified low band.

12. A spectrum detector/analyzer as claimed in claim 10, wherein the sampling frequency Fₛ for the sampler is selected to be higher than the highest frequency in any of the sub-bands.

13. A spectrum detector/analyzer as claimed in claim 8, wherein the baseband processor comprises:
a wavelet decomposition unit, for decomposing the digitized samples into wavelets using a frequency-time map with time-frequency cells of a selected granularity;
a wavelet coefficient calculator for determining the wavelet coefficients for the time-frequency cells as a measure of energy in a respective cell, and identifying the piece of unused spectrum based on thresholds.

14. A spectrum detector/analyzer for detecting and analyzing signals sensed over a spectrum of width B allocated to the TV broadcast, comprising:
an antenna unit for acquiring wireless signals present over the spectrum allocated to the TV broadcast;
a sampler for sampling the signals acquired by the antenna unit to provide digitized samples, the sampler being operated so as to achieve a saturated state for signals stronger than a specified value; and
a baseband (BB) processor for analyzing the digitized samples received from the sampler and identifying a piece of unused spectrum in the bandwidth allocated to the TV broadcast by detecting the saturation state of the sampler.

15. A spectrum detector/analyzer as in claim 14, wherein the saturation point of the sampler is selected at −70 dBm, for achieving a sampler dynamic range from −118 dBm to −70 dBm.

16. A method of detecting and analyzing signals present in the spectrum allocated to the TV broadcast, comprising:
a) acquiring wireless signals present in the band allocated to the TV broadcast;
b) sampling the signals acquired in step a) to provide digitized samples, using a sampler operated in a operating point selected to achieve a saturated state for signals stronger than a specified value; and
c) analyzing the digitized samples received from the sampler and identifying a piece of unused spectrum in the bandwidth allocated to the TV broadcast by detecting the saturation state of the sampler.

17. A method as claimed in claim 16, wherein step b) comprises sampling the signals from −118 dBm to −70 dBm, so that signals with a strength greater than −70 dBm, produce a constant output.

18. A method of detecting and analyzing signals present in a spectrum of width B allocated to the TV broadcast, comprising:
a) establishing n sub-band over the band B of the spectrum allocated to the TV broadcast, a sub-band SBₖ having a certain width Bₖ where k ε[1,n] and n≧1;
b) acquiring wireless signals present in the sub-band SBₖ;
c) down-converting the signals acquired in the sub-band SBₖ to low-band signals in a low band of a width Bₖ;
d) sampling the low-band signals in each sub-band SBₖ to provide digitized samples of the low-band signals;
e) analyzing the digitized samples received from the sampler to measure the energy of the sampled low-band signals; and
f) repeating steps c) to e) until a piece of unused spectrum is identified in the bandwidth allocated to the TV broadcast.

19. A method as in claim 18, wherein step c) comprises:
band-pass filtering the signals sensed in a respective sub-band SBₖ;
down-converting the signals in the respective sub-band SBₖ into the low-band signals; and
configuring the antenna unit, the band-pass filter and the tuner to process the signals in the respective sub-band SBₖ under control of a sub-band switch control signal.

20. A method as claimed in claim 18, wherein a frequency Fₜᵤₙₑᵣ used for down-converting the signals in all sub-bands is determined in accordance with the width of the specified low-band.

21. A method as claimed in claim 18, wherein step d) is performed using a sampling frequency Fₛ selected to be higher than the highest frequency in any of the sub-bands.

22. A method for detecting and analyzing signals sensed over a spectrum of width B allocated to the TV broadcast, comprising, comprising:
a) acquiring any wireless signals present in the spectrum allocated to the TV broadcast;
b) sampling the signals acquired by the antenna unit to provide digitized samples from the low-band signals; and
c) analyzing the digitized samples received from the sampler; and
d) identifying a piece of unused spectrum in the bandwidth allocated to the TV broadcast by detecting a known signal sequence present in the DTV broadcast according to a respective DTV standards pertinent of the TV broadcast.

23. A method as claimed in claim 22, wherein step c) is performed using wavelet signal analysis.

24. A method as claimed in claim 22, wherein step c) comprises:
decomposing the digitized samples into wavelets using a frequency-time map with time-frequency cells of a selected granularity;
determining the wavelet coefficients for the time-frequency cells as a measure of energy in a respective cell; and
identifying the piece of unused spectrum based on preset energy thresholds.

25. A method as claimed in claim 22, further comprising updating a white-space database with the information obtained in step d).

26. A method as claimed in claim 22, wherein step a) comprises:
accessing a white-space database that maintains information about current occupancy of the spectrum allocated to the TV broadcast; and
acquiring wireless signals present in the parts of the spectrum allocated to the TV broadcast which are indicated free in the white space database.

27. A method of detecting and analyzing signals present in the spectrum allocated to the TV broadcast, comprising:
a) identifying from a white space database a group of TV channels which are free to use for implementing a secondary service;
b) acquiring wireless signals present in the group of TV channels, while down-converting any detected signal to a pre-selected frequency f₀;
c) summing the signals acquired at b) to obtain a digitized composite signal;
d) reducing noise in the composite signal using a wavelet noise reduction procedure;
e) analyzing the composite signal to determine if the energy of the composite signal is higher than a threshold; and
f) if the energy of the composite signal is less than the threshold analyzing the composite signal to identify presence of a wireless microphone operation; and
g) reserving any of the channels of the group of TV channels for the secondary service if no wireless microphone operation is detected at step f).

28. A method as claimed in claim 27, further comprising, if the energy of the composite signal is less than the threshold,
separating the channels in the group into a first and a second subgroup, and
performing steps c)-g) for each subgroup in turn.
